(19) United States
(12) Patent Application Publication
(10) Pub. No.: US 2010/0234259 A1
(43) Pub. Date: Sep. 16, 2010

(54) PERFUMES

(76) Inventors: Stephen Norman Batchelor, Wirral (GB); Mansur Sultan Mohammadi, Wirral (GB); Glyn Roberts, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/669,977

(22) PCT Filed: Jul. 25, 2008
(86) PCT No.: PCT/EP2008/059818

§ 371 Date: Apr. 9, 2010

(30) Foreign Application Priority Data
Jul. 27, 2007 (GB) 0714613.7

(51) Int. Cl. C11D 3/50

(52) U.S. Cl. 510/103; 510/101

(57) ABSTRACT

The invention provides a laundry cleaning and/or care composition comprising, separately, a photo-bleach which is not a pro-fragrance (and which is preferably a singlet oxygen photo-bleach) and a pro-fragrance which is not itself a photo-bleach. The pro-fragrance preferably comprises at least one, non-aromatic, C—C double-bond, more preferably at least two C—C double-bonds, and can be advantageously be a commonplace lipid, more preferably a plant-oil. Suitable photo-bleaches comprise water-soluble phthalocyanine compounds. Preferably, the composition further comprises a shading dye to give an overall blue or violet hue to articles laundered, an optional fluorescer and/or a fabric-substantive polymer as a perfume deposition aid. Also disclosed is a method of laundering fabrics using said composition and the use of said composition to perfume fabrics.

### TECHNICAL FIELD

The present invention concerns improvements relating to perfumes and particularly to the in-situ generation of perfume components by laundry treatment compositions.

### BACKGROUND OF THE INVENTION

Perfume is one of the most expensive components of many cleaning compositions. In order to effectively deliver perfume it is necessary to ensure that perfume is not lost during storage or products and that perfume is effectively deposited during the cleaning process. Many bleach components of laundry and other cleaning compositions are known to interact with perfume components as a consequence it has been suggested to either select bleach components and perfumes which do not react or to separate perfume components from bleach components in many products.

It has therefore been suggested that perfume components for use in formulations with those catalysts which make use (either directly or indirectly) of atmospheric oxygen should be selected so as to minimise interaction between the perfume components and the bleach catalyst. In laundry tablets for example, any bleaching agents present and any perfume components can be placed in different layers of the tablets.

Other approaches have been taken to ensuring that perfumes deposit and/or are released at the appropriate time.

WO 2002/038120 (P&G) relates to photo-labile pro-fragrance conjugates which upon exposure to electromagnetic radiation are capable of releasing a fragrant species. By the use of these pro-fragrances it is believed possible to delay perfume release (and hence perfume loss). Other proposals for controlling deposition and release of perfumes have included the use of deposition aids and/or encapsulation.

WO99/60990 (P&G) discloses other photo-labile pro-fragrances. The pro-fragrances disclosed may have photo-sensitive structures including, alpha-keto esters related to acetophenone (see structures I and II). It is believed that the mechanism by which the fragrance is released involves the formation of a hydrogen radical at, for example a 2-alkanoyl benzoate or 2-benzoyl benzoate and a subsequent intra-molecular reaction resulting in the cleavage of an ester-bond to release an alcohol perfume component. It is also suggested that radicals can transfer from pro-fragrance molecule to pro-fragrance molecule.

### BRIEF DESCRIPTION OF THE INVENTION

We have now determined that a broad class of pro-fragrances can be converted to volatile odoriferous species by separate photo-bleaches and that this can be used both to provide inexpensive perfumes and improve perfume delivery.

According to the present invention there is provided a laundry cleaning and/or care composition comprising, separately, a photo-bleach and a pro-fragrance.

In the context of the present invention a “photo-bleach” is any chemical species (other than a pro-fragrance) which forms a reactive bleaching species on exposure to sunlight, and preferably is not permanently consumed in the reaction. Preferred photo-bleaches include radical photo-bleaches and, more preferably, singlet oxygen photo-bleaches. Suitable photo-bleaches are described in more detail below.

In the context of the present invention a pro-fragrance is any chemical species (other than a photo-bleach) which is a precursor of a volatile odoriferous compound and may be converted into the volatile odoriferous compound (or a further precursor thereof) by the presence of an active photo-bleach.

Use of a photo-bleach to transform a pro-fragrance into a fragrance enables relatively inexpensive and commonplace materials to be used as the pro-fragrance, and avoid the necessity of including both a photo-responsive centre (such as one related to acetophenone) and a labile fragrance component in the same molecule. Advantageously, the use of a separate photo-bleach, as opposed to a pro-fragrance which comprises a photo-sensitive portion, reduces the level of photo-sensitive materials which need be incorporated in the formulation. This is of particular benefit where the photo-bleach imparts a colour on the material being treated.

Preferred pro-fragrances contain at least one, non-aromatic, C—C double-bond, more preferably at least two C—C double-bonds. Preferably, the pro-fragrance is a lipid. Lipids are widely available at low cost and can advantageously be converted in perfume components by photo-bleaches, particularly by the singlet oxygen photo-bleaches.

In a preferred case, the pro-fragrance is one which upon exposure to the photo-bleach is converted into one or more volatile odoriferous components with a lower olfactive perception threshold than the lipid: i.e. it can be detected by the human nose at a lower level at a temperature of 20° C.

Preferred lipids contain mono- or di-unsaturated fatty acids (or their salts). Surprisingly, oxidation by photo-bleach appears to reduce the production of a rancid, oily “off” odour. For example, oleic acid oxidises to produce nonanal (described as fruity), decanal (waxy orange), 2-undecenal (orange) and 2tr-decenal (orange peel). Linoleic acid produces 3-nonelanl (cucumber like), hexanal (powerful fruity, green), heptanal (powerful, fruity vinous), octenal (orange) and 2c-octenal (walnut). Linolenic acid produces 2tr-pentenal (apple), 2,4,7-decatrienal (green, leafy), and 3c-hexenal (green, leafy).

It is believed that the compounds initially formed during the low temperature oxidation of lipids differ (either in kind or level) from those produced at higher temperatures or from prolonged oxidation. Hexanal (powerful fruity, green) dominates the volatile composition in low temperature oxidation of linoleates, whereas at higher temperatures 2,4-decadienal dominates.

Plant oils contain small level of sterols (for example peanut oil contains 6.2 mg/kg of cholesterol but the major component is beta-sistestrol˜1,145 g/kg in peanut, 1.317 g/kg in soya), carotenoids which play an important antioxidant role in fat and oils, some tocopherol (wheat germ oil has the largest level 133 mg/kg) and vitamins/pro-vitamins other than those already mentioned. These can also be oxidised to aroma chemicals.

For example, the oxidative degradation of carotenoids gives rise to useful aroma compounds. Alpha-carotene generates alpha-ionone as found in raspberry, beta-carotene generates beta-ionone found in rasberry, passion fruit and black tea, and neoxathin generates beta-damascenone found in coffee, beer, honey, wine and apple.

Preferred levels of photo-bleach present in the composition are from 0.00001 to 0.05 wt % preferably 0.00005 to 0.01%. Generally, a lower level of photo-bleach is used than would be used in practice where the objective of the photo-bleach was simply stain removal.

Preferred levels of lipid present in the composition are from 0.01 to 5 wt % preferably from 0.05 to 1.0% in fabric washing applications. All percentages used anywhere in this specification being in wt % unless otherwise stated.

Headspace analysis of cotton cloth which has been laundered and dried indoors as opposed to cloth dried outdoors in sunlight shows that many natural odours, particularly aldehydes, which can be obtained by the reaction of photo-bleaches with plant oils can be recovered at low levels from the outdoor sun-dried cloth but not from the indoor dried cloth. It is believed that this may be due to the natural action of sunlight on cotton cloth. Ensuring that these aldehydes are produced, or increasing the level of their production, provides a strong olfactive cue to users.

As noted above, some of the photo-bleaches impart colour to the fabric. To give the clothes an appealing white hue, it is preferred if shading dyes are used in combination with the photo-bleaches. Suitable shading dyes are those with a blue or violet hue, or those which when used in combination with photo-bleaches give a blue or violet hue. In the alternative a combination of photo-bleaches is used to generate a white hue. Preferred overall hue angles are 250 and 320, preferably 270 to 300.

Preferred dyes are as described in WO2005/003274 (Unilever) and WO2005/003277 (Unilever). Particularly preferred shading dyes are bis azo direct dyes, particularly those of the direct violet 9, 35 and 99 type and acid azine dyes such as acid violet 50 and acid blue 98. Alternative shading dyes are described below.

The present invention also provides a method of laundering fabrics which comprises the step of treating the fabrics with a composition according to the present invention.

The present invention also extends to the use of a photo-bleach to convert a pro-fragrance, and in particular a lipid, into a perfume component during either use or storage of a laundry product.

### DETAILED DESCRIPTION OF THE INVENTION

In order that the present invention may be further understood it is described below with reference to various preferred features.

### Bleach Catalysts

As noted above the photo-bleaches suitable for use in the present invention include singlet oxygen photo-bleaches and radical photo-bleaches. Singlet oxygen photo-bleaches are preferred as these are believed to be less likely to engage in side-reactions.

### Singlet Oxygen Photo-Bleaches:

Singlet oxygen photo-bleaches (PB) function as follows:

PB+light→PB*

PB*+³O₂→PB+¹O₂

The photo-bleach molecule absorbs light and attains an electronical excited state, PB*. This electronically excited state is quenched by triplet oxygen, ³O₂, in the surroundings to form singlet ¹O₂. Singlet oxygen is a highly reactive bleach.

Suitable singlet oxygen photo-bleaches may be selected from, water soluble phthalocyanine compounds, particularly metallated phthalocyanine compounds where the metal is Zn or Al-Z1 where Z1 is a halide, sulphate, nitrate, carboxylate, alkanolate or hydroxyl ion. Preferably the phthalocyanin has 1-4 SO₃X groups covalently bonded to it where X is an alkali metal or ammonium ion. Such compounds are described in WO2005/014769 (Ciba).

Xanthene type dyes are preferred, particularly based on the structure:

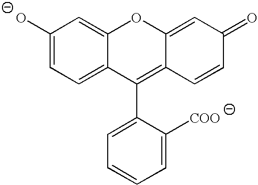

where the dye may be substituted by halogens and other elements/groups. Particularly preferred examples are Food Red 14 (Acid Red 51), Rose Bengal, Phloxin B and Eosin Y.

Quantum yields for photosensitized formation of singlet oxygen may be found in J. Phys. Chem. Ref. Data 1993, vol 22, nol pp 113-262. It is preferred if the quantum yield for singlet oxygen formation measured in an organic solvent or D2O is greater than 0.05, more preferably greater than 0.1.

Other singlet oxygen producing compounds include chlorophyll, coumarin, porphyrins, myoglobin, riboflavin, bilirubin, and methylene blue.

The singlet oxygen photo-bleaches generally impart some colour to the fabric. To give the clothes an appealing white hue, it is preferred if blue or violet shading dyes are used. As noted above, preferred overall hue angles are between 250 and 320, preferably 270 to 300 for the combination of the photo-bleach and the shading dye on the cloth.

Preferably the photo-bleaches are used in combination with the shading dyes as described in WO2005/003274 (Unilever) and WO2005/003277 (Unilever). Particularly preferred shading dyes are bis azo direct dyes of the direct violet 9, and 99 type and acid azine dyes such as acid violet 50 and acid blue 98.

In the alternative, combination of photo-bleaches can be employed to give an appropriate hue. Particularly advantageous results are obtained by use of the combination of a xanthene and a phthalocyanine photo-bleach. In particular, excellent results are obtained with a combination of an acid red xanthene photo-bleach a green-blue sulphonated Zn/Al phthalocyanine photo-bleach.

### Radical Photo-Bleaches:

Radical photo-bleaches (radical photo-initiators) are well known chemicals in the plastics and curing industry. These application have been widely discussed in the literature see e.g. H. F. Gruber Prog. Polym. Sci. 17 (1992), 953-1044 and references therein. They are organic chemicals which on exposure to light react to form neutral radicals that may initiate the polymerization of alkenes. Recently they have been found to be effective laundry photo-bleaches: UK patent application 9917451.8 teaches their use from main wash detergent powders and liquids, where the photo-initiators are intimately mixed into the powder or liquids.

Radical photo-bleaches are molecules that absorb light (typically 290-400 nm) to produce organic carbon-centered radicals.

Radical photo-bleaches may function by intermolecular hydrogen abstraction or by intramolecular alpha or beta bond cleavage.

Suitable radical photo-bleaches may be selected from quinones, ketones, aldehydes, and phosphine oxides. Preferably the maximum extinction coefficient is between 290 and 400 nm (measured in ethanol) is greater 10, more preferably greater than 100 mol-1 L cm-1.

A particularly preferred class of radical photo-bleaches are based on the structure:

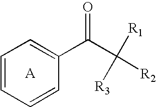

### Where

R1 may be H, OH, Oalkyl preferably methoxy or ethoxy
R2 may be H, C1-C9 alkyl branched or linear
R3 may be H, C1-C9 alkyl

Preferably R1, R2 and R3 are hydrogen

The phenyl ring, A, may be substitute at the 3, 4 and 5 position by:

C₁-C₉ allyl branched of linear, preferably methyl, ethyl, OR4 where R4 may be C1-C9 alkyl branched of linear, preferably methyl, ethyl,

Preferred examples of this type are acetophenone, 4 methyl acetophenone, 4 methoxy acetophenone. Benzophenone and vitamin K3 are also preferred radical photo-bleach.

Other suitable bond cleavage radical photo initiators may be selected from the following groups:
(a) alpha amino ketones, particularly those containing a benzoyl moiety, otherwise called alpha-amino acetophenones, for example 2-methyl 1-[4-phenyl]-2-morpholinopropan-1-one (Irgacure 907, trade mark), (2-benzyl-2-dimethyl amino-1-(4-morpholinophenyl)-butan-1-one (Irgacure 369, trade mark);
(b) alphahydroxy ketones, particularly alpha-hydroxy acetophenones, eg (1-[4-(2-hydroxyethoxy)-phenyl]-2-hydroxy-2-methyl-1-propan-1-one) (Irgacure 2959, trade mark), 1-hydroxy-cyclohexyl-phenyl-ketone (Irgacure 184, trade mark);
(c) phosphorus-containing photoinitiators, including monoacyl and bisacyl phosphine oxide and sulphides, for example 2-4-6-(trimethylbenzoyl)diphenyl-phosphine oxide, bis(2,4,6-trimethylbenzoyl)-phenyl-phosphine oxide (Irgacure 819, trade mark), (2,4,6-trimethylbenzoyl)phenyl phosphinic acid ethyl ester (Lucerin TPO-L (trade mark) ex BASF);
(d) dialkoxy acetophenones;
(e) alpha-haloacetophenones; and
(f) trisacyl phosphine oxides.
(g) benzoin and benzoin based photoinitiators
(h) thioxanthene based photoinitiators

Further suitable radical photo-bleaches are disclosed in WO 9607662 (trisacyl phosphine oxides), U.S. Pat. No. 5,399,782 (phosphine sulphides), U.S. Pat. No. 5,410,060, EP-A-57474, EP-A-73413 (phosphine oxides), EP-A-088050, EP-A-0117233, EP-A-0138754, EP-A-0446175 and U.S. Pat. No. 4,559,371.

Yet further suitable photo-bleaches are disclosed for example in EP-A-0003002 in the name of Ciba Geigy, EP-A-0446175 in the name of Ciba Geigy, GB 2259704 in the name of Ciba Geigy (alkyl bisacyl phosphine oxides), U.S. Pat. No. 4,792,632 (bisacyl phosphine oxides), U.S. Pat. No. 5,554,663 in the name of Ciba Geigy (alpha amino acetophenones), U.S. Pat. No. 5,767,169 (alkoxy phenyl substituted bisacyl phosphine oxides) and U.S. Pat. No. 4,719,297 (acylphosphine compounds).

Radical photo-bleaches are discussed in general in A. F. Cunningham, V. Desorby, K. Dietliker, R. Husler and D. G. Leppard, Chemia 48 (1994) 423-426. They are discussed in H. F. Gruber Prog. Polym. Sci. 17 (1992) 953-1044.

Inorganic photo-bleaches, including titanium dioxide are not excluded, but are less preferred.

In the context of the present invention the photo-bleach will typically have a cleaning function as well as reacting with the pro-fragrance. However, as noted above, the level of the photo-bleach can be such that the cleaning effect per-se is small.

### Pro-Fragrance:

The pro-fragrances used in the present invention may themselves have a characteristic odour or may not. Generally, they will be materials with a low odour or no perceivable odour and the levels used.

The reaction of the pro-fragrance with the activated photo-bleach may be a single step reaction which produces the volatile odoriferous component directly or may be one step in a multi-step reaction. A pro-fragrance may produce a single volatile odoriferous component or it may produce a mixture of components. Preferably, the volatile odoriferous component comprises an aldehyde.

Aldehydes used in perfumes include but are not limited to phenylacetaldehyde, p-methyl phenylacetaldehyde, p-isopropyl phenylacetaldehyde, methylnonyl acetaldehyde, phenylpropanal, 3-(4-t-butylphenyl)-2-methyl propanal, 3-(4-t-butylphenyl)-propanal, 3-(4-methoxyphenyl)-2-methylpropanal, 3-(4-isopropylphenyl)-2-methylpropanal, 3-(3,4-methylenedioxyphenyl)-2-methylpropanal, 3-(4-ethylphenyl)-2,2-dimethylpropanal, phenylbutanal, 3-methyl-5-phenylpentanal, hexanal, trans-2-hexenal, cis-hex-3-enal, heptanal, cis-4-heptenal, 2-ethyl-2-heptenal, 2,6-dimethyl-5-heptenal, 2,4-heptadienal, octanal, 2-octenal, 3,7-dimethyloctanal, 3,7-dimethyl-2,6-octadien-1-al, 3,7-dimethyl-1,6-octadien-3-al, 3,7-dimethyl-6-octenal, 3,7-dimethyl-7-hydroxyoctan-1-al, nonanal, 6-nonenal, 2,4-nonadienal, 2,6-nonadienal, decanal, 2-methyl decanal, 4-decenal, 9-decenal, 2,4-decadienal, undecanal, 2-methyldecanal, 2-methylundecanal, 2,6,10-trimethyl-9-undecenal, undec-10-enyl aldehyde, undec-8-enanal, dodecanal, tridecanal, tetradecanal, anisaldehyde, bourgenonal, cinnamic aldehyde, a-amylcinnam-aldehyde, a-hexyl cinnamaldehyde, methoxy-cinnamaldehyde, citronellal, hydroxy-citronellal, isocyclocitral, citronellyl oxyacet-aldehyde, cortexaldehyde, cumminic aldehyde, cyclamen aldehyde, florhydral, heliotropin, hydrotropic aldehyde, lilial, vanillin, ethyl vanillin, benzaldehyde, p-methyl benzaldehyde, 3,4-dimethoxybenzaldehyde, 3- and 4-(4-hydroxy-4-methyl-pentyl)-3-cyclohexene-1-carboxaldehyde, 2,4-dimethyl-3-cyclohexene-1-carboxaldehyde, 1-methyl-3-(4-methylpentyl)-3-cyclohexen-carboxaldehyde, p-methylphenoxyacetaldehyde, and mixtures thereof.

As noted above, preferred pro-fragrances contain at least one, non-aromatic, C—C double-bond, more preferably at least two C—C double-bonds.

Particularly preferred pro-fragrances comprise the structure (I) below:

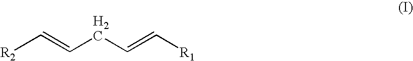

It is believed that this structure is the site of the reaction with the photo-bleach, R₁ and R₂ are selected such that fragmentation of the molecule following exposure to the photo-bleach leads to the production of an odoriferous compound.

One suitable class of pro-fragrance comprises food lipids. Food lipids typically contain structural units with pronounced hydrophobicity. The majority of lipids are derived from fatty acids. In these ‘acyl’ lipids the fatty acids are predominantly present as esters and include mono-, di-, triacyl glycerols, phospholipids, glycolipids, diol lipids, waxes, sterol esters and tocopherols.

In their natural state, plant lipids comprise antioxidants to prevent their oxidation. While these may be at least in part removed during the isolation of oils from plants some antioxidants may remain. These antioxidants can be pro-fragrances. In particular, the carotenoids and related compounds including vitamin A, retinol, retinal, retinoic acid and provitamin A are capable of being converted into fragrant species including the ionones, damascones and damscenones as mentioned above.

Preferred food lipids include olive oil, palm oil, canola oil, squalene, sunflower seed oil, wheat germ oil, almond oil, coconut oil, grape seed oil, rapeseed oil, castor oil, corn oil, cottonseed oil, safflower oil, groundnut oil, poppy seed oil, palm kernel oil, rice bran oil, sesame oil, soybean oil, pumpkin seed oil. jojoba oil and mustard seed oil.

Preferred food lipids also include oils and fats of animal source including butter, ghee, and squalene. To avoid allergic reaction, certain nut oils (peanut oil, for example) are less preferred.

The most preferred pro-fragrance contain at least 20 wt % of a compound which comprises the moiety

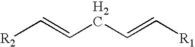

Where R1 and R2 are organic groups containing carbon, hydrogen and oxygen. A preferred example is linoleic acid.

Particularly preferred lipids contain 10 wt % or less of moieties containing three double bonds, (such as linolenic acid). Also the most preferred lipids contain less than 15 wt % saturated acids and less than 15 wt % of acids with less than 14 carbon atoms. Within these preferred limits branched-chain and hydroxyl acid moieties are included

Most preferred oils exclude those of high linolenic content (preferred<10%), such as hemp oil (˜25% wt linolenic acid), and oils of nut origin.

Particularly preferred pro-fragrances are olive oil, sunflower oil, soybean oil, palm oil, rapeseed oil, squalene, and mixtures thereof.

While some non-soap surfactants may contain very low levels of compounds derived from unsaturated alkyl chains, it is not intended that the present invention should extend to such compositions.

### Shading Dyes:

As noted above an optional shading dye can be used to counteract the tendency of the photo-bleach to move the hue of fabrics away from white. Preferred dyes are violet or blue, or in combination with the photo-bleach yield a violet or blue shade. Suitable and preferred classes of dyes are discussed below.

### Direct Dyes:

Direct dyes (otherwise known as substantive dyes) are the class of water soluble dyes which have a affinity for fibres and are taken up directly. Direct violet and direct blue dyes are preferred.

Preferably the dye are bis-azo or tris-azo dyes are used.

Most preferably, the direct dye is a direct violet of the following structures:

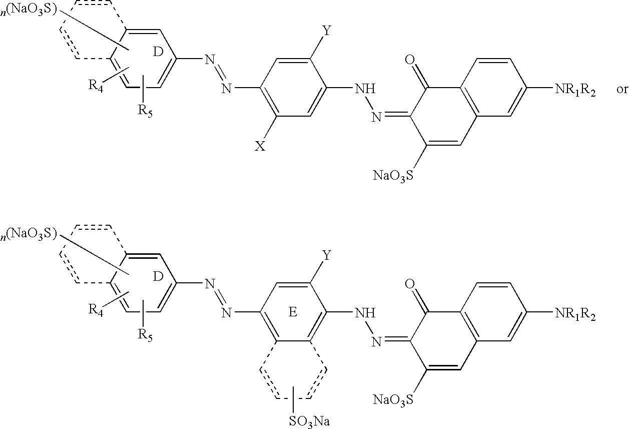

wherein:
ring D and E may be independently naphthyl or phenyl as shown;
R₁ is selected from: hydrogen and C1-C4-alkyl, preferably hydrogen;
R₂ is selected from: hydrogen, C1-C4-alkyl, substituted or unsubstituted phenyl and substituted or unsubstituted naphthyl, preferably phenyl;
R₃ and R₄ are independently selected from: hydrogen and C1-C4-alkyl, preferably hydrogen or methyl;
X and Y are independently selected from: hydrogen, C1-C4-alkyl and C1-C4-alkoxy; preferably the dye has X=methyl; and, Y=methoxy and n is 0, 1 or 2, preferably 1 or 2.

Preferred dyes are direct violet 7, direct violet 9, direct violet 11, direct violet 26, direct violet 31, direct violet 35, direct violet 40, direct violet 41, direct violet 51, and direct violet 99. Bis-azo copper containing dyes such as direct violet 66 may be used.

The benzidene based dyes are less preferred.

Preferably the direct dye is present at 0.00001 wt % to 0.0010 wt % of the formulation.

In another embodiment the direct dye may be covalently linked to the photo-bleach, for example as described in WO2006/024612.

An alternative to the azo dyes are the blue or violet triphenodioxazine direct dyes.

A suitable example of this is the triphenodioxazine direct dye is of the form:

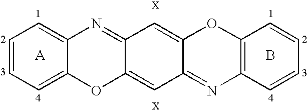

wherein the dye is substituted by 1 to 4 sulphonate groups and X is independently selected from: C₁-C₆-alkyl, alkyl ester, benzyl, F, Cl, Br and I.

### Acid Dyes:

Cotton substantive acid dyes give benefits to cotton containing garments. Preferred dyes and mixes of dyes are blue or violet. Preferred acid dyes are:
(i) azine dyes, wherein the dye is of the following core structure:

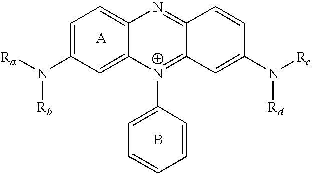

wherein Rₐ, R_{b}, R_{c} and R_{d} are selected from: H, an branched or linear C1 to C7-alkyl chain, benzyl a phenyl, and a naphthyl;
the dye is substituted with at least one SO₃⁻ or —COO⁻ group; the B ring does not carry a negatively charged group or salt thereof; and the A ring may further substituted to form a naphthyl; the dye is optionally substituted by groups selected from: amine, methyl, ethyl, hydroxyl, methoxy, ethoxy, phenoxy, Cl, Br, I, F, and NO₂.

Preferred azine dyes are: acid blue 98, acid violet 50, and acid blue 59, more preferably acid violet 50 and acid blue 98.

Other preferred non-azine acid dyes are acid violet 17, acid black 1 and acid blue 29.

Preferably the acid dye is present at 0.0005 wt % to 0.01 wt % of the formulation.

### Hydrophobic Dyes

The composition may comprise one or more hydrophobic dyes selected from benzodifuranes, methine, triphenylmethanes, napthalimides, pyrazole, napthoquinone, anthraquinone and mono-azo or di-azo dye chromophores. Hydrophobic dyes are dyes which do not contain any charged water solubilising group. Hydrophobic dyes may be selected from the groups of disperse and solvent dyes. Blue and violet anthraquinone and mono-azo dye are preferred.

Preferred dyes include solvent violet 13, disperse violet 27 disperse violet 26, disperse violet 28, disperse violet 63 and disperse violet 77.

Preferably the hydrophobic dye is present at 0.0001 wt % to 0.005 wt % of the formulation.

### Basic Dyes:

Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International.

Preferred examples include triarylmethane basic dyes, methane basic dye, anthraquinone basic dyes, basic blue 16, basic blue 71, basic blue 159, basic violet 19, basic violet 35, basic violet 38, basic violet 48; basic blue 3, basic blue 75, basic blue 95, basic blue 122, basic blue 124, basic blue 141. Thiazolium dyes may also be used, examples are basic blue 41, 54, 65, 66, 67, 162 and 164.

### Reactive Dyes

Reactive dyes are dyes which contain an organic group capable of reacting with cellulose and linking the dye to cellulose with a covalent bond. They deposit onto cotton.

Preferably the reactive group is hydrolysed or reactive group of the dyes has been reacted with an organic species such as a polymer, so as to the link the dye to this s species. Dyes may be selected from the reactive violet and reactive blue dyes listed in the Colour Index International.

Preferred examples include reactive blue 19, reactive blue 163, reactive blue 182 and reactive blue, reactive blue 96.

### Dye Conjugates:

Dye conjugates are formed by binding direct, acid or basic dyes to polymers or particles via physical forces.

Dependent on the choice of polymer or particle they deposit on cotton or synthetics. A description is given in WO2006/055787. They are not preferred.

Particularly preferred dyes are: direct violet 7, direct violet 9, direct violet 11, direct violet 26, direct violet 31, direct violet 35, direct violet 40, direct violet 41, direct violet 51, direct violet 54, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof.

In a particularly preferred embodiment, the compositions of the present invention comprise:
a) photo-bleach, preferably comprising at least one phthalocyanine, preferably at a level of 0.00001-1 wt %
b) pro-fragrance, preferably at a level of 0.1-10% wt and
c) a blue violet dye, preferably with an optical adsorption peak in the range 540-600 nm, preferably a bis-azo direct dye, preferably at a level of 0.000001-1 wt %

### Fluorescent Agents:

In order to further improve whiteness, especially in the presence of both the photo-bleach and the shading dye, but also in the absence of the shading dye it is convenient and advantageous to include a fluorescer in the compositions of the invention. The composition therefore preferably further comprises a fluorescent agent (optical brightener).

Fluorescent agents are well known and many such fluorescent agents are available commercially. Usually, these fluorescent agents are supplied and used in the form of their alkali metal salts, for example, the sodium salts.

The total amount of the fluorescent agent or agents used in the composition is generally from 0.005 to 2 wt %, more preferably 0.01 to 0.1 wt %.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN.

Preferred fluorescers are: sodium 2 (4-styryl-3-sulfophenyl)-2H-napthol[1,2-d]trazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfoslyryl)biphenyl.

In a particularly preferred embodiment, the compositions of the present invention comprise:
a) photo-bleach, preferably comprising at least one phthalocyanine, preferably at 0.00001-1 wt %
b) pro-fragrance, preferably at 0.1-10% wt and
c) fluorescer, preferably at a level of 0.005 to 2 wt %

It is preferred to use a shading dye in combination with a fluorescer in order to reduce yellowing due to chemical changes in adsorbed fluorescer.

### Polymers:

The composition may comprise one or more polymers. Examples are carboxymethylcellulose, poly(vinylpyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid copolymers.

Modern detergent compositions typically employ polymers as so-called ‘dye-transfer inhibitors’. These prevent migration of dyes, especially during long soak times. Any suitable dye-transfer inhibition agents may be used in accordance with the present invention. Generally, such dye-transfer inhibiting agents include polyvinyl pyrrolidone polymers, polyamine N-oxide polymers, copolymers of N-vinylpyrrolidone and N-vinylimidazole, manganese pthalocyanine, peroxidases, and mixtures thereof.

Nitrogen-containing, dye binding, DTI polymers are preferred. Of these polymers and co-polymers of cyclic amines such as vinyl pyrrolidone, and/or vinyl imidazole are preferred.

Polyamine N-oxide polymers suitable for use herein contain units having the following structural formula: R-Aₓ-P; wherein P is a polymerizable unit to which an N—O group can be attached or the N—O group can form part of the polymerizable unit; A is one of the following structures: —NC(O)—, —C(O)O—, —S—, —O—, —N═; x is 0 or 1; and R is an aliphatic, ethoxylated aliphatic, aromatic, heterocyclic or alicyclic group or combination thereof to which the nitrogen of the N—O group can be attached or the N—O group is part of these groups, or the N—O group can be attached to both units.

Preferred polyamine N-oxides are those wherein R is a heterocyclic group such as pyridine, pyrrole, imidazole, pyrrolidine, piperidine and derivatives thereof. The N—O group can be represented by the following general structures: N(O)(R′)₀₋₃, or ═N(O)(R′)₀₋₁, wherein each R′ independently represents an aliphatic, aromatic, heterocyclic or alicylic group or combination thereof; and the nitrogen of the N—O group can be attached or form part of any of the aforementioned groups. The amine oxide unit of the polyamine N-oxides has a pKₐ<10, preferably pKₐ<7, more preferably pKₐ<6.

Any polymer backbone can be used provided the amine oxide polymer formed is water-soluble and has dye transfer inhibiting properties. Examples of suitable polymeric backbones are polyvinyls, polyalkylenes, polyesters, polyethers, polyamides, polyimides, polyacrylates and mixtures thereof. These polymers include random or block copolymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate copolymerization or by an appropriate degree of N-oxidation. The polyamine oxides can be obtained in almost any degree of polymerization. Typically, the average molecular weight is within the range of 500 to 1,000,000; more preferably 1,000 to 500,000; most preferably 5,000 to 100,000. This preferred class of materials is referred to herein as “PVNO”. A preferred polyamine N-oxide is poly(4-vinylpyridine-N-oxide) which as an average molecular weight of about 50,000 and an amine to amine N-oxide ratio of about 1:4.

Copolymers of N-vinylpyrrolidone and N-vinylimidazole polymers (as a class, referred to as “PVPVI”) are also preferred. Preferably the PVPVI has an average molecular weight range from 5,000 to 1,000,000, more preferably from 5,000 to 200,000, and most preferably from 10,000 to 20,000, as determined by light scattering as described in Barth, et al., Chemical Analysis, Vol. 113. “Modern Methods of Polymer Characterization”. The preferred PVPVI copolymers typically have a molar ratio of N-vinylimidazole to N-vinylpyrrolidone from 1:1 to 0.2:1, more preferably from 0.8:1 to 0.3:1, most preferably from 0.6:1 to 0.4:1. These copolymers can be either linear or branched. Suitable PVPVI polymers include Sokalan™ HP56, available commercially from BASF, Ludwigshafen, Germany.

Also preferred as dye transfer inhibition agents are polyvinylpyrrolidone polymers (“PVP”) having an average molecular weight of from about 5,000 to about 400,000, preferably from about 5,000 to about 2000,000, and more preferably from about 5,000 to about 50,000. PVP's are disclosed for example in EP-A-262,897 and EP-A-256,696. Suitable PVP polymers include Sokalan™ HP50, available commercially from BASF. Compositions containing PVP can also contain polyethylene glycol (“PEG”) having an average molecular weight from about 500 to about 100,000, preferably from about 1,000 to about 10,000. Preferably, the ratio of PEG to PVP on a ppm basis delivered in wash solutions is from about 2:1 to about 50:1, and more preferably from about 3:1 to about 10:1.

Also suitable as dye transfer inhibiting agents are those from the class of modified polyethyleneimine polymers, as disclosed for example in WO-A-0005334. These modified polyethyleneimine polymers are water-soluble or dispersible, modified polyamines. Modified polyamines are further disclosed in U.S. Pat. No. 4,548,744; U.S. Pat. No. 4,597,898; U.S. Pat. No. 4,877,896; U.S. Pat. No. 4,891,160; U.S. Pat. No. 4,976,879; U.S. Pat. No. 5,415,807; GB-A-1,537,288; GB-A-1,498,520; DE-A-28 29022; and JP-A-06313271.

Preferably the composition according to the present invention comprises a dye transfer inhibition agent selected from polyvinylpyrridine N-oxide (PVNO), polyvinyl pyrrolidone (PVP), polyvinyl imidazole, N-vinylpyrrolidone and N-vinylimidazole copolymers (PVPVI), copolymers thereof, and mixtures thereof.

The amount of dye transfer inhibition agent in the composition according to the present invention will be from 0.01 to 10%, preferably from 0.02 to 5%, more preferably from 0.03 to 2%, by weight of the composition. It will be appreciated that the dye transfer inhibition agents will assist in the preservation of whiteness by preventing the migration of dyes from coloured articles to white ones.

Other polymers used in laundry compositions include soil-release and anti-redeposition polymers as well as polymers which improve powder properties.

Polymeric dispersing agents can advantageously be utilized in the compositions herein, especially in the presence of layered silicate builders. Suitable polymeric dispersing agents include polycarboxylates and polyethylene glycols, although others known in the art can also be used.

It is also believed that polymeric dispersing agents enhance overall detergent builder performance, when used in combination with other builders (including lower molecular weight polycarboxylates) by crystal growth inhibition, particulate soil release, peptization, and anti-redeposition.

Polycarboxylate materials, which can be prepared by polymerizing or copolymerizing suitable unsaturated monomers, are preferably admixed in their acid form. Unsaturated monomeric acids that can be polymerized to form suitable polycarboxylates include acrylic acid, maleic acid (or maleic anhydride), fumaric acid, itaconic acid, aconitic acid, mesaconic acid, citraconic acid and methylenemalonic acid. The presence in the polycarboxylates herein of monomeric segments, containing no carboxylate radicals such as vinylmethyl ether, styrene, ethylene, etc. is suitable provided that such segments do not constitute more than about 40% by weight of the polymer.

Particularly suitable polycarboxylates can be derived from acrylic acid. Such acrylic acid-based polymers which are useful herein are the water-soluble salts of polymerized acrylic acid. The average molecular weight of such polymers in the acid form preferably ranges from about 2,000 to 10,000, more preferably from about 4,000 to 7,000 and most preferably from about 4,000 to 5,000. Water-soluble salts of such acrylic acid polymers can include, for example, the alkali metal, ammonium and substituted ammonium salts. Soluble polymers of this type are known materials. Use of polyacrylates of this type in detergent compositions has been disclosed, for example, in Diehl, U.S. Pat. No. 3,308,067, issued Mar. 7, 1967. In the present invention, the preferred polycarboxylate is sodium polyacrylate.

Acrylic/maleic-based copolymers may also be used as a preferred component of the dispersing/anti-redeposition agent. Such materials include the water-soluble salts of copolymers of acrylic acid and maleic acid. The average molecular weight of such copolymers in the acid form preferably ranges from about 2,000 to 100,000, more preferably from about 5,000 to 75,000, most preferably from about 7,000 to 65,000. The ratio of acrylate to maleate segments in such copolymers will generally range from about 30:1 to about 1:1, more preferably from about 10:1 to 2:1. Water-soluble salts of such acrylic acid/maleic acid copolymers can include, for example, the alkali metal, ammonium and substituted ammonium salts. Soluble acrylate/maleate copolymers of this type are known materials which are described in European Patent Application No. 66915, published Dec. 15, 1982, as well as in EP 193,360, published Sep. 3, 1986, which also describes such polymers comprising hydroxypropylacrylate. Still other useful dispersing agents include the maleic/acrylic/vinyl alcohol terpolymers. Such materials are also disclosed in EP 193,360, including, for example, the 45/45/10 terpolymer of acrylic/maleic/vinyl alcohol.

Polyethylene glycol (PEG) can exhibit dispersing agent performance as well as act as a clay soil removal-antiredeposition agent. Typical molecular weight ranges for these purposes range from about 500 to about 100,000, preferably from about 1,000 to about 50,000, more preferably from about 3,000 to about 10,000. Polyaspartate and polyglutamate dispersing agents may also be used. Dispersing agents such as polyaspartate preferably have an average molecular weight of about 10,000.

Any polymeric soil release agent known to those skilled in the art can optionally be employed in compositions according to the invention. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of washing and rinsing cycles and, thus, serve as an anchor for the hydrophilic segments. This can enable stains occurring subsequent to treatment with the soil release agent to be more easily cleaned in later washing procedures.

Generally the soil release polymers will comprise polymers of aromatic dicarboxylic acids and alkylene glycols (including polymers containing polyalkylene glycols).

The polymeric soil release agents useful herein especially include those soil release agents having:
(a) one or more nonionic hydrophilic components consisting essentially of:
   (i) polyoxyethylene segments with a degree of polymerization of at least 2, or
   (ii) oxypropylene or polyoxypropylene segments with a degree of polymerization of from 2 to 10,
      wherein said hydrophile segment does not encompass any oxypropylene unit unless it is bonded to adjacent moieties at each end by ether linkages, or
   (iii) a mixture of oxyalkylene units comprising oxyethylene and from 1 to about 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the soil release agent on such surface, said hydrophile segments preferably comprising at least about 25% oxyethylene units and more preferably, especially for such components having about 20 to 30 oxypropylene units, at least about 50% oxyethylene units; or
(b) one or more hydrophobe components comprising:
   (i) C₃ oxyalkylene terephthalate segments, wherein, if said hydrophobe components also comprise oxyethylene terephthalate, the ratio of oxyethylene terephthalate:C₃ oxyalkylene terephthalate units is about 2:1 or lower,
   (ii) C₄-C₆ alkylene or oxy C₄-C₆ alkylene segments, or mixtures therein,
   (iii) poly (vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b).

Typically, the polyoxyethylene segments of (a) (i) will have a degree of polymerization of from about 200, although higher levels can be used, preferably from 3 to about 150, more preferably from 6 to about 100. Suitable oxy C₄-C₆ alkylene hydrophobe segments include, but are not limited to, end-caps of polymeric soil release agents such as MO₃S(CH₂)ₙOCH₂ CH₂O—, where M is sodium and n is an integer from 4-6, as disclosed in U.S. Pat. No. 4,721,580, issued Jan. 26, 1988 to Gosselink.

Polymeric soil release agents useful in the present invention also include cellulosic derivatives such as hydroxyether cellulosic polymers, copolymeric blocks of ethylene terephthalate or propylene terephthalate with polyethylene oxide or polypropylene oxide terephthalate, and the like. Such agents are commercially available and include hydroxyethers of cellulose such as METHOCEL (Dow). Cellulosic soil release agents for use herein also include those selected from the group consisting of C₁-C₄ alkyl and C₄ hydroxyalkyl cellulose; see U.S. Pat. No. 4,000,093, issued Dec. 28, 1976 to Nicol, et al.

Soil release agents characterized by poly(vinyl ester) hydrophobe segments include graft copolymers of poly(vinyl ester), e.g., C₁-C₆ vinyl esters, preferably poly(vinyl acetate) grafted onto polyalkylene oxide backbones, such as polyethylene oxide backbones. See European Patent Application 0 219 048, published Apr. 22, 1987 by Kud, et al. Commercially available soil release agents of this kind include the SOKALAN type of material, e.g., SOKALAN HP-22, available from BASF (West Germany).

One type of preferred soil release agent is a copolymer having random blocks of ethylene terephthalate and polyethylene oxide (PEO) terephthalate. The molecular weight of this polymeric soil release agent is in the range of from about 25,000 to about 55,000. See U.S. Pat. No. 3,959,230 to Hays, issued May 25, 1976 and U.S. Pat. No. 3,893,929 to Basadur issued Jul. 8, 1975.

Another preferred polymeric soil release agent is a polyester with repeat units of ethylene terephthalate units contains 10-15% by weight of ethylene terephthalate units together with 90-80% by weight of polyoxyethylene terephthalate units, derived from a polyoxyethylene glycol of average molecular weight 300-5,000. Examples of this polymer include the commercially available material ZELCON 5126 (from DuPont) and MILEASE T (from ICI). See also U.S. Pat. No. 4,702,857, issued Oct. 27, 1987 to Gosselink.

Another preferred polymeric soil release agent is a sulfonated product of a substantially linear ester oligomer comprised of an oligomeric ester backbone of terephthaloyl and oxyalkyleneoxy repeat units and terminal moieties covalently attached to the backbone. These soil release agents are described fully in U.S. Pat. No. 4,968,451, issued Nov. 6, 1990 to J. J. Scheibel and E. P. Gosselink. Other suitable polymeric soil release agents include the terephthalate polyesters of U.S. Pat. No. 4,711,730, issued Dec. 8, 1987 to Gosselink et al, the anionic end-capped oligomeric esters of U.S. Pat. No. 4,721,580, issued Jan. 26, 1988 to Gosselink, and the block polyester oligomeric compounds of U.S. Pat. No. 4,702,857, issued Oct. 27, 1987 to Gosselink.

Preferred polymeric soil release agents also include the soil release agents of U.S. Pat. No. 4,877,896, issued Oct. 31, 1989 to Maldonado et al, which discloses anionic, especially sulfoarolyl, end-capped terephthalate esters.

If utilised, soil release agents will generally comprise from about 0.01% to about 10.0%, by weight, of the detergent compositions herein, typically from about 0.1% to about 5%, preferably from about 0.2% to about 3.0%.

Still another preferred soil release agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate end-caps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)-ethanesulfonate. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof.

It is believed that those polymers which deposit on cloth as a part of their activity may assist in the deposition of the pro-fragrance, perfume generated from the pro-fragrance and/or other perfume components present. Other types of polymeric deposition aid may also be used. These include cationic polymeric deposition aids. Suitable cationic polymeric deposition aids include cationic guar polymers such as Jaguar (ex Rhone Poulenc), cationic cellulose derivatives such as Celquats (ex National Starch), Flocald (ex National Starch), cationic potato starch such as SoftGel (ex Aralose), cationic polyacrylamides such as PCG (ex Allied Colloids). Cationic polymeric aids are particularly preferred in the absence of any other cationic material in the composition.

Particularly preferred compositions according to the present invention comprise:
a) at least one photo-bleach, preferably a phthalocyanine photo-bleach, preferably at level of 0.00001-1 wt %;
b) at least one pro-fragrance, preferably at a level of 0.001 to 10 wt %, more preferably 0.1 to 2 wt %
c) at least one shading dye, preferably a bis-azo direct dye, preferably with an optical adsorption peak in the range 540-600 nm, preferably at a level of 0.000001-1 wt %;
d) at least one fluorescer, preferably selected from the group comprising: di-styryl biphenyl compounds, di-amine stilbene di-sulphonic acid compounds and pyrazoline compounds, preferably at a level of 0.005 to 2 wt %; and,
e) optionally, a polymeric deposition aid for the pro-fragrance and/or perfume, which, when present is preferably a soil release polymer comprising residues of aromatic dicarboxylic acids and alkylene glycols.

### Other Components:

In a preferred embodiment a composition of the invention also contains one or more surfactants and/or optionally other ingredients such that the composition is fully functional as a laundry cleaning and/or care composition. A composition of the invention may be in dry solid or liquid form. The composition may be a concentrate to be diluted, rehydrated and/or dissolved in a solvent, including water, before use. The composition may also be a ready-to-use (in-use) composition.

The present invention is suitable for use in industrial or domestic fabric wash compositions, fabric conditioning compositions and compositions for both washing and conditioning fabrics (so-called through the wash conditioner compositions). The present invention can also be applied to industrial or domestic non-detergent based fabric care compositions, for example spray-on compositions.

Fabric wash compositions according to the present invention may be in any suitable form, for example powdered, tableted powders, liquid or solid detergent bars.

Other contemplated ingredients including surfactants, hydrotropes, preservatives, fillers, builders, complexing agents, stabilizers, perfumes per se, other conventional detergent ingredients, or combinations of one or more thereof are discussed below. The composition may also contain other conventional detergent ingredients such as e.g. fabric conditioners including clays, foam boosters, suds suppressors (anti-foams), anti-corrosion agents, anti-microbials or tarnish inhibitors.

### Surfactants:

Fabric wash compositions according to the present invention comprise a fabric wash detergent material selected from non-soap anionic surfactant, nonionic surfactants, soap, amphoteric surfactants, zwitterionic surfactants and mixtures thereof.

Detergent compositions suitable for use in domestic or industrial automatic fabric washing machines generally contain anionic non-soap surfactant or nonionic surfactant, or combinations of the two in suitable ratio, as will be known to the person skilled in the art, optionally together with soap.

Many suitable detergent-active compounds are available and fully described in the literature, for example in “Surface-Active Agents and Detergents”, Volumes I and II, by Schwartz, Perry & Berch.

The surfactants may be present in the composition at a level of from 0.1% to 60% by weight.

Suitable anionic surfactants are well known to the person skilled in the art and include alkyl benzene sulphonate, primary and secondary alkyl sulphates, particularly C₈-C₁₅ primary alkyl sulphates; alkyl ether sulphates; olefin sulphonates; alkyl xylene sulphonates, dialkyl sulphosuccinates; ether carboxylates; isethionates; sarcosinates; fatty acid ester sulphonates and mixtures thereof. The sodium salts are generally preferred. When included therein the composition usually contains from about 1% to about 50%, preferably 10 wt %-40 wt % based on the fabric treatment composition of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap. Preferred surfactants are alkyl ether sulphates and blends of alkoxylated alkyl nonionic surfactants with either alkyl sulphonates or alkyl ether sulphates.

Preferred alkyl ether sulphates are C8-C15 alkyl and have 2-10 moles of ethoxlation. Preferred alkyl sulphates are alkylbenzene sulphonates, particularly linear alkylbenzene sulphonates having an alkyl chain length of C₈-C₁₅. The counter ion for anionic surfactants is typically sodium, although other counter-ions such as TEA or ammonium can be used. Suitable anionic surfactant materials are available in the marketplace as the ‘Genapol’™ range from Clariant.

Nonionic surfactants are also well known to the person skilled in the art and include primary and secondary alcohol ethoxylates, especially C₈-C₂₀ aliphatic alcohol ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl polyglycosides, glycerol monoethers and polyhydroxy amides (glucamide). Mixtures of nonionic surfactant may be used. When included therein the composition usually contains from about 0.2% to about 40%, preferably 1 to 20 wt %, more preferably 5 to 15 wt % of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Nonionic surfactants that may be used include the primary and secondary alcohol ethoxylates, especially the C₈-C₂₀ aliphatic alcohols ethoxylated with an average of from 1 to 35 moles of ethylene oxide per mole of alcohol, and more especially the C₁₀-C₁₅ primary and secondary aliphatic alcohols ethoxylated with an average of from 1 to 10 moles of ethylene oxide per mole of alcohol.

Higher levels of surfactant may be employed (up to almost 100%) but this can leave little space in the formulation for builders and other components and may lead to a sticky product which requires special processing.

### Hydrotropes:

The term “hydrotrope” generally means a compound with the ability to increase the solubilities, preferably aqueous solubilities, of certain slightly soluble organic compounds. Examples of hydrotropes include sodium xylene sulfonate, SCM.

### Solvents:

The composition may comprise a solvent such as water or an organic solvent such as isopropyl alcohol or glycol ethers. Solvents are typically present in liquid or gel compositions.

### Metal Chelation Agents:

The composition may contain a metal chelating agent such as carbonates, bicarbonates, and sesquicarbonates. The metal chelating agent can be a bleach stabiliser (i.e. heavy metal sequestrant). Suitable metal chelation agents include ethylenediamine tetraacetate (EDTA), diethylenetriamine pentaacetate (DTPA), ethylenediamine disuccinate (EDDS), and the polyphosphonates such as the Dequests (Trade Mark), ethylenediamine tetramethylene phosphonate (EDTMP) and diethylenetriamine pentamethylene phosphate (DETPMP).

### Builders or Complexing Agents:

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

The composition may also contain 0-65% of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Where builder is present, the compositions may suitably contain less than 20% wt, preferably less than 10% by weight, and most preferably less than 10% wt of detergency builder.

The composition may contain as builder a crystalline aluminosilicate, preferably an alkali metal aluminosilicate, more preferably a sodium aluminosilicate. This is typically present at a level of less than 15% w. Aluminosilicates are materials having the general formula:

0.8-1.5M₂O.Al₂O₃.0.8-6SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

For low cost formulations carbonate (including bicarbonate and sesquicarbonate) and/or citrate may be employed as builders.

### Enzymes:

One or more enzymes may be present in a composition of the invention and when practicing a method of the invention.

Especially contemplated enzymes include proteases, alpha-amylases, cellulases, lipases, peroxidases/oxidases, pectate lyases, and mannanases, or mixtures thereof.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105,

WO 95/35381, WO 96/00292, WO 95/30744, WO 94/25578, WO 95/14783, WO 95/22615, WO 97/04079 and WO 97/07202.

Preferred commercially available lipase enzymes include Lipolase™ and Lipolase Ultra™, Lipex™ (Novozymes A/S).

The method of the invention may be carried out in the presence of phospholipase classified as EC 3.1.1.4 and/or EC 3.1.1.32. As used herein, the term phospholipase is an enzyme which has activity towards phospholipids. Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

The enzyme and the pro-fragance may show some interaction and should be chosen such that this interaction is not negative. Some negative interactions may be avoided by encapsulation of one or other of enzyme and pro-fragrance and/or other segregation within the product.

Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Preferred commercially available protease enzymes include Alcalase™, Savinase™, Primase™, Duralase™, Dyrazym™, Esperase™, Everlase™, Polarzyme™, and Kannase™, (Novozymes A/S), Maxatase™, Maxacal™, Maxapem™, Properase™, Purafect™, Purafect OxP™, FN2™, and FN3™ (Genencor International Inc.).

The method of the invention may be carried out in the presence of cutinase. classified in EC 3.1.1.74. The cutinase used according to the invention may be of any origin. Preferably cutinases are of microbial origin, in particular of bacterial, of fungal or of yeast origin.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO95/026397 or WO 00/060060. Commercially available amylases are Duramyl™, Termamyl™, Termamyl Ultra™, Natalase™, Stainzyme™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. No. 4,435,307, U.S. Pat. No. 5,648,263, U.S. Pat. No. 5,691,178, U.S. Pat. No. 5,776,757, WO 89/09259, WO 96/029397, and WO 98/012307. Commercially available cellulases include Celluzyme™, Carezyme™, Endolase™, Renozyme™ (Novozymes A/S), Clazinase™ and Puradax HA™ (Genencor International Inc.), and KAC-500(B)™ (Kao Corporation).

Suitable peroxidases/oxidases include those of plant, bacterial or fungal origin. Chemically modified or protein engineered mutants are included. Examples of useful peroxidases include peroxidases from Coprinus, e.g. from C. cinereas, and variants thereof as those described in WO 93/24618, WO 95/10602, and WO 98/15257. Commercially available peroxidases include Guardzyme™ and Novozym™ 51004 (Novozymes A/S).

### Enzyme Stabilizers:

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

### Perfumes Per Se:

Compositions according to the present invention will preferably also comprise some perfume per se. Useful components of the perfume include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products, i.e., of imparting an odor and/or a flavour or taste to a consumer product traditionally perfumed or flavoured, or of modifying the odour and/or taste of said consumer product.

By perfume in this context is not only meant a fully formulated product fragrance, but also selected components of that fragrance, particularly those which are prone to loss, such as the so-called ‘top notes’.

Top notes are defined by Poucher (Journal of the Society of Cosmetic Chemists 6(2):80 [1955]). Examples of well known top-notes include citrus oils, linalool, linalyl acetate, lavender, dihydromyrcenol, rose oxide and cis-3-hexanol. Top notes typically comprise 15-25% wt of a perfume composition and in those embodiments of the invention which contain an increased level of top-notes it is envisaged at that least 20% wt would be present within the encapsulate.

Some or all of the perfume or pro-fragrance may be encapsulated, typical perfume components which it is advantageous to encapsulate, include those with a relatively low boiling point, preferably those with a boiling point of less than 300, preferably 100-250 Celsius and pro-fragrances which can produce such components.

It is also advantageous to encapsulate perfume components which have a low Log P (ie. those which will be partitioned into water), preferably with a Log P of less than 3.0. These materials, of relatively low boiling point and relatively low Log P have been called the “delayed blooming” perfume ingredients and include the following materials:

Allyl Caproate, Amyl Acetate, Amyl Propionate, Anisic Aldehyde, Anisole, Benzaldehyde, Benzyl Acetate, Benzyl Acetone, Benzyl Alcohol, Benzyl Formate, Benzyl Iso Valerate, Benzyl Propionate, Beta Gamma Hexenol, Camphor Gum, Laevo-Carvone, d-Carvone, Cinnamic Alcohol, Cinamyl Formate, Cis-Jasmone, cis-3-Hexenyl Acetate, Cuminic Alcohol, Cyclal C, Dimethyl Benzyl Carbinol, Dimethyl Benzyl Carbinol Acetate, Ethyl Acetate, Ethyl Aceto Acetate, Ethyl Amyl Ketone, Ethyl Benzoate, Ethyl Butyrate, Ethyl Hexyl Ketone, Ethyl Phenyl Acetate, Eucalyptol, Eugenol, Fenchyl Acetate, Flor Acetate (tricyclo Decenyl Acetate), Frutene (tricycico Decenyl Propionate), Geraniol, Hexenol, Hexenyl Acetate, Hexyl Acetate, Hexyl Formate, Hydratropic Alcohol, Hydroxycitronellal, Indone, Isoamyl Alcohol, Iso Menthone, Isopulegyl Acetate, Isoquinolone, Ligustral, Linalool, Linalool Oxide, Linalyl Formate, Menthone, Menthyl Acetphenone, Methyl Amyl Ketone, Methyl Anthranilate, Methyl Benzoate, Methyl Benzyl Acetate, Methyl Eugenol, Methyl Heptenone, Methyl Heptine Carbonate, Methyl Heptyl Ketone, Methyl Hexyl Ketone, Methyl Phenyl Carbinyl Acetate, Methyl Salicylate, Methyl-N-Methyl Anthranilate, Nerol, Octalactone, Octyl Alcohol, p-Cresol, p-Cresol Methyl Ether, p-Methoxy Acetophenone, p-Methyl Acetophenone, Phenoxy Ethanol, Phenyl Acetaldehyde, Phenyl Ethyl Acetate, Phenyl Ethyl Alcohol, Phenyl Ethyl Dimethyl Carbinol, Prenyl Acetate, Propyl Bornate, Pulegone, Rose Oxide, Safrole, 4-Terpinenol, Alpha-Terpinenol, and/or Viridine

It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian. By means of the present invention these materials can be transferred to textile articles that will be worn or otherwise come into contact with the human body (such as handkerchiefs and bed-linen).

In order that the invention will be further understood it is described below with reference to the following examples:

TABLE 1
Fatty acid composition (wt %) of some food lipids.

| | 4:0 to 12:0 | 14:0 | 16:0 | 16:1 | 18:0 | 18:1 | 18:2 | 18:3 | 18:1 (OH) | 20:0 | 20:1 | 22:0 | 22:1 | 24:0) |
|---|---|---|---|---|---|---|---|---|---|---|---|---|---|---|
| Ghee | 6-17 | 5-15 | 25-41 | 2-6 | 6-11 | 18-33 | 0-4 | 0 | | 0-2 | 0-2 | | 0-2 | |
| (butter fat) | | | | | | | | | | | | | | |
| Grapeseed oil | | | 7 | 0 | 3 | 22 | 67 | 0.9 | | 0.1 | | | | |
| Hemp seed oil | | | 6 | | 2 | 12 | 55 | 25 | | | | | | |
| Sunflower oil | | | 6 | 0.1 | 5.6 | 17.8 | 68.7 | 0.2 | | 0.3 | | 0.8 | | 0.1 |
| Rapeseed oil | | | | | | | | | | | | | | |
| (high erucic | | | 3 | | 1 | 16 | 14 | 10 | | 1 | 6 | | 49 | |
| acid rape) | | | | | | | | | | | | | | |
| (low erucic | | | 4 | | 2 | 56 | 26 | 10 | | | 2 | 0.2 | | |
| acid rape) | | | | | | | | | | | | | | |
| Cocoa butter | | 0.1 | 26 | 0.3 | 34.4 | 34.8 | 3 | 0.2 | | 1 | | | | |
| Castor oil | | | | 1 | 1 | 3 | 4 | 0 | 90 | | | | | |
| Olive oil | | | 10 | 0.7 | 2.3 | 78.1 | 7.3 | 0.6 | | 0.4 | 0.3 | | | |
| Palm | | 0-2 | 32-45 | | 2-7 | 38-52 | 5-11 | | | | | | | |
| Soy oil | | | 11 | 0.5 | 4 | 22 | 53 | 7.5 | | 1 | 1 | | | |

### EXAMPLES

### Example 1

20% emulsions of the lipids were prepared in a bench-top jacketed mixer using a three-blade impeller at 500 RPM and a process temperature of 50° C. The lipids were heated to −50° C. and added drop-wise into a 1% solution of non-ionic surfactant (Genapol LA 070, ex Clariant). After sufficient mixing the batch was cooled slowly to room temperature and the emulsion decanted into a bottle and further treated in a Silverson high shear homogeniser (one minute mixing at the lowest speed setting).

Cotton sheeting monitors roughly 20×20 cm were padded with these emulsions in the following manner. A 500 ml glass bottle filled with 200 g of tap water to which 20 or 10 g of the above 20% emulsion was weighed in and shaken. To this a fixed level of photo-bleach was weighed in and shaken. Then two monitors were added and agitated on a roller for some 30 minutes. The monitors then removed and spin dried. From the monitor's dry and wet weight and the concentration of emulsion the amount of lipid (emulsion) could be calculated.

TABLE 2
Amount of lipid picked up by monitors for 20 g of
emulsion and an average 0.090 mg of Acid Red 51
per g of fabric.

| | dry | padded | | Mg oil/g |
|---|---|---|---|---|
| Lipids | weight/g | weight/g | pick up/g | fabric |
| Soy oil | 12.56 | 27.37 | 14.81 | 21.44 |
| Ryoto sugar | 12.52 | 27.24 | 14.72 | 21.31 |
| ester ER290 | | | | |
| Soy oil sugar | 12.44 | 27.06 | 14.62 | 21.16 |
| ester | | | | |
| Estol 1476 | 12.7 | 27.62 | 14.92 | 21.60 |
| Sirius M40 | 13.09 | 28.03 | 14.94 | 21.63 |
| Extra virgin | 15.08 | 32.51 | 17.43 | 25.23 |
| olive oil | | | | |
| Palm and Canola | 15.63 | 32.51 | 16.88 | 24.44 |
| oil | | | | |
| Coconut oil | 15.18 | 32.64 | 17.46 | 25.28 |
| Squalene | 15.16 | 31.83 | 16.67 | 24.13 |

Acid Red 51 is erythrosine B (ex Aldrich). Ryoto sucrose ester is a food grade oil based on erucate (22:1) lipid source (ex Mitsubishi). Soy oil sucrose ester is touch hardened oil (ex Clariant). The sucrose esters have an average of 4 ester linkage. Estol 1476 is isobutyl stearate (ex Uniqema). Sirius M40 is a mainly C12-C20 light mineral oil (ex Silkolene) Squalene is a polyunsaturated triterpene (C₃₀) oil (ex Sigma). The remaining oils were purchased off the shelf from supermarkets (Tesco).

TABLE 3
Amount of lipid picked up by monitors for 10 g of
emulsion for two photobleach treatments of an
average of 0.090 mg of Acid Red 51 and an average
of 0.246 mg of pentyl-phenyl ketone per g of
fabric.

| | dry | padded | | mg oil/g |
|---|---|---|---|---|
| Lipids | weight/g | weight/g | pick up/g | fabric |
| Ghee | 12.74 | 27.76 | 15.02 | 11.23 |
| Grapeseed oil | 12.72 | 27.59 | 14.87 | 11.13 |
| Hemp oil | 12.11 | 26.11 | 14.00 | 11.01 |
| Sunflower oil | 12.08 | 26.05 | 13.97 | 11.01 |
| Rapeseed oil | 12.04 | 26.62 | 14.58 | 11.53 |
| Cocoa Soft | 12.26 | 27.73 | 15.47 | 12.02 |
| Pumpkin oil | 12.16 | 27.98 | 15.82 | 12.39 |
| Sweet almond | 12.31 | 26.79 | 14.48 | 11.20 |
| oil | | | | |
| Castor oil | 12.32 | 27.60 | 15.28 | 11.81 |
| Jojoba oil | 12.10 | 26.26 | 14.16 | 11.15 |

Pentyl-phenyl ketone or hexanophenone is a radical photo-bleach (ex Aldrich). Cocoa Soft was Lipex Cococasoft (ex AAK). Castor oil was a pure grade (ex Now). Jojoba oil was (ex Henry Lamotte). The Sweet almond oil was (ex Provital SA). The remaining oils purchased off the shelf from a supermarket (Tesco).

The two monitors treated for each lipid and each photo-bleach were dried one on line (inside) and one in Weather-o-meter™ (WOM) for 30 minutes. WOM produces artificial sunlight and was set up to give 385 W/m² in the UV-visible range (290-750 nm).

Monitor 1 was the line dried control (C)) against which the Weather-o-meter monitor 2 (W) was judged. The monitors were kept in closed top bottles under florescent light condition to be presented to panel members to evaluate the quality of the odours in the headspace and on the monitors. The odour descriptors used were based on those known in the art. The panel members described the odour and assigned a number to quantify the intensity of the odour they perceived.

The odour comparison between the saturated oil Estol 1476 and Sirius M40 and the oils containing unsaturation revealed that the Weather-o-meter irradiated samples of the unsaturated lipids from the start had developed a sharp “ozonic”, bleach type penetrating odour labelled as “pungent”. It is not necessarily an unpleasant odour and most of the time connoted a ‘clean’ fabric note not dissimilar to outside line dried laundried fabrics.

TABLE 4
Odour description of oils same day for line
dried (C) and weather-o-meter dried (W).

| | | | Olive | | Palm & | | Coconut | | | |
|---|---|---|---|---|---|---|---|---|---|---|
| | | | oil | | Canola | | oil | | Squalene | |
| | | | treatment | | | | | | | |
| | ↑ | Odour | C | W | C | W | C | W | C | W |
| | \| | Fruity | | 1 | | | | | | 2 honey |
| | | | | | | | | | | caramel |
| | \| | Green | | | 1 | | | | | 2 |
| Pleasant | \| | Clean | | 1 | 1 | | 1 | | | 1 |
| | \| | Soapy | | | | | 1 | | 1 | 1 |
| | \| | Dairy | | | | | | | | |
| | \| | Pungent | | 2 | | 2 | | | | 1 |
| | \| | Oily | 1 | 1 | 2 | 2 | | 2 | 1 | |
| | | Tallowy | | | | 1 | | | | |
| | | Frying oil | | | | 1 | | 2 | | |
| | | Stale nut | | | | | | | | |
| | | Fishy | | | | | | | | |

TABLE 5
Odour description after one day standing under fluorescent light.

| | | | Olive | | Palm & | | Coconut | | | |
|---|---|---|---|---|---|---|---|---|---|---|
| | | | oil | | Canola | | oil | | Squalene | |
| | | | treatment | | | | | | | |
| | ↑ | Odour | C | W | C | W | C | W | C | W |
| | \| | Fruity | | | | 1 | | | 1 sweet | 2 honey |
| | | | | | | | | | | caramel |
| | \| | Green | | | | | | | | 1 |
| Pleasant | \| | Clean | 1 | 1 | | | 1 | | 1 | 1 |
| | \| | Soapy | 1 | 1 | 1 | 1 | 1 | | | 1 |
| | \| | Dairy | | | | | | | | |
| | \| | Pungent | | 3 | | | | 1 | | 1.5 |
| | \| | Oily | 2 | 1 | 1 | 1 | 1 | 0.5 | 1 | |
| | | Tallowy | | | 1 | 1 | 1 | 0.5 | | |
| | | Frying oil | | | | | | | | |
| | | Stale nut | | | | 1 | 1 | | | |
| | | Fishy | | | | | | | | |

The light induced oxidation products of squalene were particularly noteworthy in their distinct and unmistakable potent perfume quality.

TABLE 6
Odour description and intensity of oils with Red Acid 51 photo bleach first day.

| | | | | | Grapeseed | | Hemp | | Sunflower | | Rapeseed | |
|---|---|---|---|---|---|---|---|---|---|---|---|---|
| | | | Ghee | | oil | | oil | | Oil | | oil | |
| | | | treatment | | | | | | | | | |
| | ↑ | Odour | C | W | C | W | C | W | C | W | C | W |
| | \| | Fruity | | | | | | | | | 1 | 1 |
| | \| | Green | | | | | | | 2 | | | |
| Pleasant | \| | Clean | 1 | | | | | | | | | |
| | \| | Soapy | | 1 | | | | | | | 1 | 1 |
| | \| | Dairy | | 2 | | | | | | | | |
| | \| | Pungent | | 2 | | 1 | | | | | | |
| | \| | Oily | | | 1 | 2 | | | 1 | 1 | 1 | 1 |
| | \| | Tallowy | | | | | | | | | | |
| | | Frying oil | | | | | | | | | | |
| | | Stale nut | | | | | | | | 2 | | |
| | | Fishy | | | | | 2 | 3 | | | | |

| | Cocoasoft | | Pumpkin oil | | Sweet Almond | | Castor oil | | Jojoba oil | |
|---|---|---|---|---|---|---|---|---|---|---|
| | C | W | C | W | C | W | C | W | C | W |
| Fruit | | 0.5 | | 0.5 | | | 0.5 | | | |
| Green | 0.5 | | 0.5 | 1.5 | | | 1.5 | | 0.5 | |
| Clean | 0.5 | 1 | | | 1 | | 1.5 | 1 | 1.5 | 2 |
| Soap | 0.5 | | 0.5 | | 1 | | | | | 1.5 |
| Dairy | 1 | | | | | | | | | |
| Pungent | | 0.5 | | 1.5 | | 1 | | 0.5 | | 1.5 |
| Oily | | 0.5 | | | | 0.5 | | 0.5 | | |
| Tallowy | | | 0.5 | | | | | | | |
| Frying oil | | 1 | 2 | 2.5 | | | | 1 | | |
| Stale nut | | 0.5 | 1.5 | 2 | | | | | | |
| Fish | | | | | | | | | | |

TABLE 7
Odour description and intensity of oils with of 0.246
mg of phentyl-phenyl ketone per g of fabric.

| | Ghee | | Grapeseed | | Hemp | | Sunflower | | Rapeseed | |
|---|---|---|---|---|---|---|---|---|---|---|
| | C | W | C | W | C | W | C | W | C | W |
| Fruity | | | 1 | | | 1 | 1 | | 1 | |
| Green | | | | | | | 1 | | 2 | 1 |
| Clean | | | | | | | 1 | | 2 | |
| Soapy | 1 | | | 2 | | | 1 | | | |
| Dairy | 1 | 2.5 | | 0 | | | 1 | 1 | | 1.5 |
| Pungent | | | | | | | | | | |
| Oily | 1 | | | | | | | | | |
| Tallowy | | | | | | | | | | |
| Frying oil | | | | | | | | 2 | | |
| Stale Nut | | | | | | | | | | |
| Fish | | | | | 2 | 2 | | | | |

Pentyl-phenyl ketone has a fruity green smell by itself and the control C and W monitors of this photo-bleach on its own were used for comparison in Table 6. The control C had an intensity of 1 fruity and 1 green. The control W on the other lost the fruity green and a pungent note of intensity 1 emerged. This fruity green note of the photo-bleach itself was perceivable on line dried treated monitors for grape seed, hemp, sunflower and rapeseed, cocoa soft, pumpkin, almond and jojoba (as indicated by an intensity of 1).

TABLE 7
(continued)
Odour description and intensity of oils with of
0.246 mg of pentyl-phenyl ketone per g of fabric.

| | | | Pumpkin | | Sweet | | Castor | | Jojoba | |
|---|---|---|---|---|---|---|---|---|---|---|
| | Cocoasoft | | oil | | Almond | | oil | | oil | |
| | C | W | C | W | C | W | C | W | C | W |
| Fruity | 1 | | | | 1 | | 1 | | 1 | |
| Green | | | 1 | | | | | | | 2 |
| Clean | | | | | 1 | | | | | |
| Soapy | | 1 | | | | | | 2 | | 2 |
| Dairy | | 2 | | | | 2 | | | | |
| Pungent | | | | | | | | | | |
| Oily | | | 1 | | | | 1 | 1 | | |
| Tallowy | | | | | | | | | | |
| Frying oil | 2 | | | | | | | | | |
| Stale Nut | | | | | | | | | | |
| Fish | | | | | | | | | | |

To determine the volatile aromas of the fatty acids themselves 20% emulsions of oleic, linoleic and linolenic acids where prepared as described for oils above and cotton sheetings padded to the levels seen in Table 3 with and without Acid Red 51 photo-bleach at a 0.0606 mg/g fabric level. The panel assessment of the odours is summarised in Table 8.

It is clear that linolenic acid with three double bonds results in a fishy off-odour which can and be detrimental to the overall perfume impact of the laundry composition.

TABLE 8
Aromas generated (after one day at 20 C.) on cotton
sheeting treated by fatty acid emulsions.

| Fatty | Without Acid Red 51 | | With Acid Red 51 | |
|---|---|---|---|---|
| acid* | C | W | C | W |
| Control | Laundry | Clean | Laundry | Clean laundry |
| (non-ionic | died | laundry | died | |
| and water) | inside | Slightly | inside | |
| | with stale | oily | with stale | |
| | slightly | | slightly | |
| | fishy | | fishy | |
| | smell | | smell | |
| Oleic | Clean | Clean | Clean | Clean fresh |
| | laundry | laundry | fresh | Sweet perfume |
| | Green | Green | pleasant | smell of |
| | cucumber | cucumber | laundry | caramel/honey |
| | | and | dried | |
| | | volatile | outside | |
| | | Ozonic | | |
| Linoleic | Clean | Clean | Clean | Clean fresh |
| | laundry | Green | Green | sweet |
| | Green | slightly | cucumber | caramel/honey |
| | cucumber | oily | | smell |
| | | | | Ozonic |
| | | | | pungent |
| | | | | volatiles |
| Linolenic | Strong | Less fishy | Strong | Less fishy |
| | fishy | Pungent | fishy | Some Green |
| | | Oily | Slight | Pungent |
| | | | green | Slightly |
| | | | | sweet caramel |

*Oleic acid was a 90% assay from Aldrich, linoleic was a 60% assay from Sigma and linolenic was a 70% assay with 25% linoleic and 5% oleic from Fluka.

### Example II

White woven cotton cloth was washed at 20° C. in 2.0 g/L of a base washing powder containing: 18% NaLAS, 73% salts (silicate, sodium tri-poly-phosphate, sulphate, carbonate), 3% minors including fluorescer and enzymes, remainder impurities and water. A liquor to cloth of 30:1 was used, each wash lasted for 30 mins, and was conducted with and without the addition of varying level of Tinolux BBS (a green-blue sulphonated Zn/Al phthalocyanine ex Ciba Speciality chemicals) and acid red 51. The level of dye was quantified by the optical absorption (5 cm pathlength) at 528 nm for acid red 51 and 670 nm for the Tinolux BBS. Following the wash, the cotton cloth was rinsed twice, dried and colour of the cloth was then assessed using a reflectometer (UV excluded for all measurements) and expressed as the hue angle. A hue angle of 180 corresponds to green, a hue angle of 270 to blue and a hue angle of 0/360 to red. The results are shown in Table 9 below:

TABLE 9

| | Absorption | |
|---|---|---|
| Absorption (AR51 | (Tinolux BBS at | |
| at 528 nm) | 670 nm) | Hue angle |
| 0 | 1.2 | 209 |
| 0.03 | 1.17 | 225 |
| 0.06 | 1.14 | 243 |
| 0.09 | 1.11 | 258* |
| 0.12 | 1.08 | 278** |
| 0.15 | 1.05 | 295** |
| 0.18 | 1.02 | 301* |
| 0.21 | 0.99 | 306* |
| 0.24 | 0.96 | 308* |
| 0.3 | 0.9 | 322 |
| 0.6 | 0.6 | 331 |
| 0.9 | 0.3 | 334 |
| 1.2 | 0 | 337 |

For whiteness preferred hue angles are between 250 and 320, preferably 270 to 300 (as marked with asterisks). As noted above, this may be provided by a mixture of an acid red xanthene photobleach and a green-blue sulphonated Zn/Al phthalocyanine photobleach.

### Example III

### Exemplary Granular Laundry Formulations A,B,C,D

TABLE 10

| | Formulation | | | |
|---|---|---|---|---|
| | A | B | C | D |
| NaLAS | 15 | 20 | 10 | 14 |
| NI(7EO) | — | — | — | 10 |
| Na tripolyphosphate | 7 | 15 | — | — |
| Soap | — | — | — | 2 |
| Zeolite A24 | — | — | — | 17 |
| Sodium silicate | 5 | 4 | 5 | 1 |
| Sodium carbonate | 25 | 20 | 30 | 20 |
| Sodium sulphate | 40 | 33 | 40 | 22 |
| Carboxymethylcellulose | 0.2 | 0.3 | — | 0.5 |
| Sodium chloride | — | — | — | 5 |
| Lipase | 0.005 | 0.01 | — | 0.005 |
| Protease | 0.005 | 0.01 | — | 0.005 |
| Amylase | 0.001 | 0.003 | — | — |
| Cellulase | — | 0.003 | — | — |
| Fluorescer | 0.1 | 0.15 | 0.05 | 0.3 |
| Direct Violet 9 | 0.0002 | 0.00015 | — | 0.0001 |
| Solvent Violet 13 | — | 0.002 | — | 0.001 |
| Acid red 51 | 0.002 | 0.002 | 0.0001 | 0.0003 |
| Direct violet 54 | — | — | 0.0001 | — |
| Sulphonated Zn | 0.002 | 0.004 | 0.0004 | 0.0005 |
| phthalocyanine photo- | | | | |
| bleach | | | | |
| profragance | 0.1 | 1.0 | 0.2 | 0.4 |
| Water/impurities/minors | remainder | remainder | remainder | remainder |

1. A laundry cleaning and/or care composition comprising, separately, a photo-bleach and a pro-fragrance.

2. A composition according to claim 1, wherein the photo-bleach is a singlet oxygen photo-bleach or a radical photo-bleach.

3. A composition according to any preceding claim, wherein the pro-fragrance comprises at least one, non-aromatic, C—C double-bond, more preferably at least two C—C double-bonds.

4. A composition according to claim 3, wherein the pro-fragrance comprises a lipid.

5. A composition according to claim 4, wherein the pro-fragrance comprises a plant oil.

6. A composition according to any preceding claim, wherein the photo-bleach comprises singlet oxygen photo bleach.

7. A composition according to claim 6, wherein the photo-bleach comprises a water-soluble phthalocyanine compound.

8. A composition according to any of claims 1-5, wherein the photo-bleach comprises a radical photo-bleach.

9. A composition according to claim 8, wherein the radical photo-bleach absorbs light to produce organic, carbon-centred radicals.

10. A composition according to claim 9, wherein the radical photo-bleach comprises the structure: 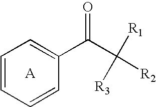
wherein: R1 may be H, OH, C1-C9 oxy-alkyl, R2 and R3 are, independently, H, C1-C9 alkyl branched or linear, and, A is optionally substituted with C1-C9 alkyl or oxyalkyl.

11. A composition according to any one of claims 1-10, wherein the pro-fragrance comprises the structure:

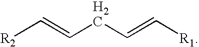

12. A composition according to claim 11, wherein the pro-fragrance comprises at least one of, olive oil, palm oil, canola oil, squalene, sunflower seed oil, wheat germ oil, almond oil, coconut oil, grape seed oil, rapeseed oil, castor oil, corn oil, cottonseed oil, safflower oil, groundnut oil, poppy seed oil, palm kernel oil, rice bran oil, sesame oil, soybean oil, pumpkin seed oil. jojoba oil and mustard seed oil.

13. A composition according to claim 11, wherein the pro-fragrance comprises 10 wt % or less of moieties containing three double bonds.

14. A composition according to claim 11, wherein the pro-fragrance comprises less than 15 wt % saturated fatty acids.

15. A composition according to claim 11, wherein the pro-fragrance comprises less than 15 wt % of fatty acids with less than 14 carbon atoms.

16. A composition according to any preceding claim, further comprising a blue or violet shading dye.

17. A composition according to claim 16, wherein the shading dye is a bis-azo or tris-azo dye.

18. A composition according to claim 16, wherein the shading dye is a direct violet comprising the following structures: 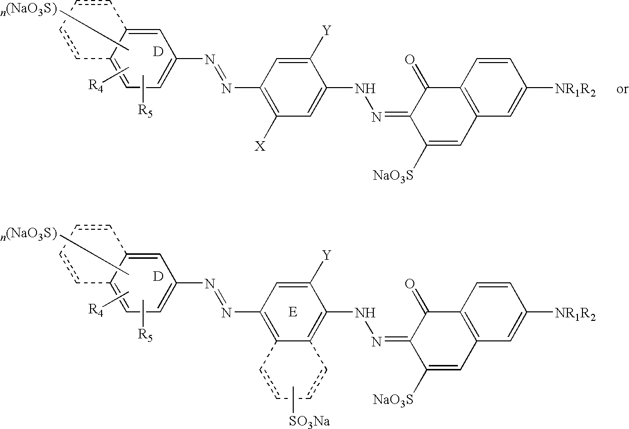
wherein: ring D and E may be independently naphthyl or phenyl as shown; R₁ is selected from: hydrogen and C1-C4-alkyl; R₂ is selected from: hydrogen, C1-C4-alkyl, substituted or unsubstituted phenyl and substituted or unsubstituted naphthyl; R₃ and R₄ are independently selected from: hydrogen and C1-C4-alkyl; X and Y are independently selected from: hydrogen, C1-C4-alkyl and C1-C4-alkoxy and n is 0, 1 or 2.

19. A composition according to claim 16, wherein the dye is selected from direct violet 7, direct violet 9, direct violet 11, direct violet 26, direct violet 31, direct violet 35, direct violet 40, direct violet 41, direct violet 51, direct violet 54, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141, reactive blue 19, reactive blue 163, reactive blue 182, reactive blue 96 and mixtures thereof.

20. A composition according to claim 16, wherein the shading dye is an azine dye comprising the following structure: 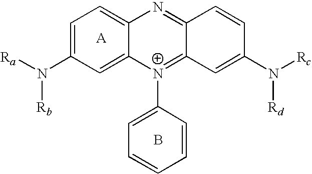
wherein Rₐ, R_{b}, Rₐ and R_{d} are selected from: H, an branched or linear C1 to C7-alkyl chain, benzyl a phenyl, and a naphthyl; the dye is substituted with at least one SO₃⁻ or —COO⁻ group; the B ring does not carry a negatively charged group or salt thereof; the A ring is optionally substituted to form a naphthyl; and the structure is optionally substituted by groups selected from: amine, methyl, ethyl, hydroxyl, methoxy, ethoxy, phenoxy, Cl, Br, I, F, NO₂ and mixtures thereof.

21. A composition according to any preceding claim, further comprising a fluorescer.

22. A composition according to any preceding claim, further comprising a fabric-substantive polymer as a deposition aid.

23. A composition according to any proceeding claims, comprising:
a) at least one photo-bleach, preferably a phthalocyanine photo-bleach, preferably at level of 0.00001-1 wt %;
b) at least one pro-fragrance, preferably at a level of 0.001 to 10 wt %, more preferably 0.1 to 2 wt %
c) at least one shading dye, preferably a bis-azo direct dye, preferably with an optical adsorption peak in the range 540-600 nm, preferably at a level of 0.000001-1 wt %;
d) at least one fluorescer, preferably selected from the group comprising: di-styryl biphenyl compounds, di-amine stilbene di-sulphonic acid compounds and pyrazoline compounds, preferably at a level of 0.005 to 2 wt %; and,
e) optionally, a polymeric deposition aid for the pro-fragrance and/or perfume.

24. A method of laundering fabrics which comprises the step of treating the fabrics with a composition according to any one of claims 1-23.

25. Use of a composition according to any one of claims 1-23 to perfume fabric articles.
